(19) United States
(12) Patent Application Publication
(10) Pub. No.: US 2024/0308570 A1
(43) Pub. Date: Sep. 19, 2024

(54) ELECTRO-HYDRAULIC METERING UNIT

(71) Applicant: Eric Amato, Greenfield, MA (US)

(72) Inventor: Eric Amato, Greenfield, MA (US)

(21) Appl. No.: 18/603,671

(22) Filed: Mar. 13, 2024

Related U.S. Application Data
(60) Provisional application No. 63/452,262, filed on Mar. 15, 2023.

(51) Int. Cl. B62D 5/00; B62D 1/04; B62D 1/12; B62D 6/00; F16H 19/08; G05G 5/03

(52) U.S. Cl. CPC B62D 5/006; B62D 1/04; B62D 1/12; B62D 6/001; F16H 19/08; G05G 5/03; G05G 2505/00

(57) ABSTRACT

An electrohydraulic steering system includes an electro-hydraulic metering unit and a control device. The electro-hydraulic metering unit includes an electric positioner operatively connected to the control device and a hand metering unit operatively connected to the electric positioner. The electro-hydraulic metering unit includes an intermediate electric positioner interface member operatively connected to the electric positioner and an intermediate interface member operatively connected to the hand metering unit and the intermediate electric positioner interface member.

### PRIORITY INFORMATION

The present application claims priority, under 35 U.S.C. §119(e), from U.S. Provisional Patent Application, Ser. No. 63/452,262, filed on Mar. 15, 2023. The entire content of U.S. Provisional Patent Application, Ser. No. 63/452,262, filed on Mar. 15, 2023, is hereby incorporated by reference.

### BACKGROUND

Off-road vehicles and heavy equipment often utilize hydrostatic steering systems in which hydraulic fluid power is responsible for vehicle steering control without the requirement for a continuous mechanical connection between the steering wheel and tires. In such conventional hydrostatic steering systems, fluid power energy is provided by a hydraulic pump and control of hydraulic oil flow to the steering actuator is performed by a hand metering unit.

The hand metering unit typically consists of a manually operated directional control servo valve coupled to a metering element in a single body and is mechanically linked to the steering wheel. Thus, when a vehicle operator initiates a turn by applying torque to the steering wheel, the servo valve directs oil flow from the pump, and the metering element delivers a fixed volume of oil to the hydraulic cylinder(s) relative to rotation of the steering wheel. This provides steering feel and response similar to that of a traditional automotive steering system. While the hand metering unit is intended to be primarily used for vehicle steering applications, it can be used for any hydraulic applications where positional control is required.

FIG. 1 illustrates a prior art hand metering unit. As Illustrated in FIG. 1, the hand metering unit 100 includes a metering element 1, typically a gerotor type positive displacement device, to regulate a fixed volume of oil to be delivered to the hydraulic cylinder/actuator (not shown) per revolution of the steering column/input 11. Drive shafts (2, 4, and 15) connect a directional control servo valve 6 to the metering element 1.

The hand metering unit 100 also includes an inlet fluid port 3 from a pump (not shown). A manual steering check valve 5 allows port T to return oil to port P so that the hand metering unit 100 can act as a hand pump for manual steering when unpowered by hydraulic flow. Port T is the return port that allows oil to return back to a tank (not shown).

When the hand metering unit 100 is powered, high pressure inlet oil at port P closes the manual steering check valve 5 and forces oil towards the directional control servo valve 6 and metering element 1.

With respect to the directional control servo valve 6, block 9 represents a neutral spool position, and blocks (7 and 13) represent flow paths when the valve spool is shifted resulting from steering column input torque.

The hand metering unit 100 includes left turn fluid port 8, outlet to left turn port on hydraulic cylinder or actuator (not shown), and right turn fluid port 10, outlet to right turn port on hydraulic cylinder or actuator (not shown).

As illustrated in FIG. 1, in a neutral spool position, port P is open to port T, left turn fluid port 8 and right turn fluid port 10 are blocked and the metering element 1 is internally blocked/isolated from the directional control servo valve 6. This illustrates one of many “valve center” and “load reaction” variations.

A centering spring 14 maintains neutral state spool position of the directional control servo valve 6 when no load is applied to the steering column/input 11.

While the above-described prior art hand metering unit can provide vehicle steering control, there has been a shift towards electrohydraulic control systems which presents opportunities to achieve greater levels of vehicle control and efficiency.

For instance, feedback from vehicle telemetry sensors, such as steering angle and vehicle speed, can be used to precisely tune vehicle dynamics and automatically prevent the steering system from trying to steer beyond maximum angle limits, thereby reducing stress on the power steering pump and other components.

Conventional electrohydraulic steering systems have been developed, which rely on either proportional electrohydraulic spool valves or servo-proportional valves. Both types of valves have tradeoffs in performance, response, and reliability.

In addition, the hardware for conventional electrohydraulic steering systems and the programming to achieve accurate controls of the proportional electrohydraulic spool valves or servo-proportional valves can be complex and expensive, making the conventional electrohydraulic steering systems difficult to integrate or retrofit into an existing vehicle without such a system already installed.

Therefore, it is desirable to provide an electrohydraulic steering system that does not need complex and expensive hardware or programing to achieve accurate control of the valves.

Moreover, it is desirable to provide an electrohydraulic steering system that accurately controls a hydraulic actuator rate and position.

Additionally, it is desirable to provide an electrohydraulic steering system that accurately controls a hydraulic actuator rate and position using readily available motor control methods and hardware.

Also, it is desirable to provide an electrohydraulic steering system that is more tolerant of oil pollution than proportional spool or servo-proportional valves.

Furthermore, it is desirable to provide an electrohydraulic steering system that has minimal hysteresis.

It is desirable to provide an electrohydraulic steering system that in the event of electrical power loss, the steering/actuator position will remain fixed in place and the electric positioner can be replaced or supplemented with manual steering input hardware as emergency backup option to adjust steering position.

Moreover, it is desirable to provide an electrohydraulic steering system that can easily support open or closed center hydraulic systems without requiring additional or complex valving and controls.

Lastly, it is desirable to provide an electrohydraulic steering system that enables a steering position to be easily and accurately adjusted by one of several methods including an electronic steering wheel/column, joystick, or automatic controller based on vehicle telemetry feedback.

### BRIEF DESCRIPTION OF THE DRAWINGS

The drawings are only for purposes of illustrating various embodiments and are not to be construed as limiting, wherein:

FIG. 1 shows an example of a conventional hand metering unit;

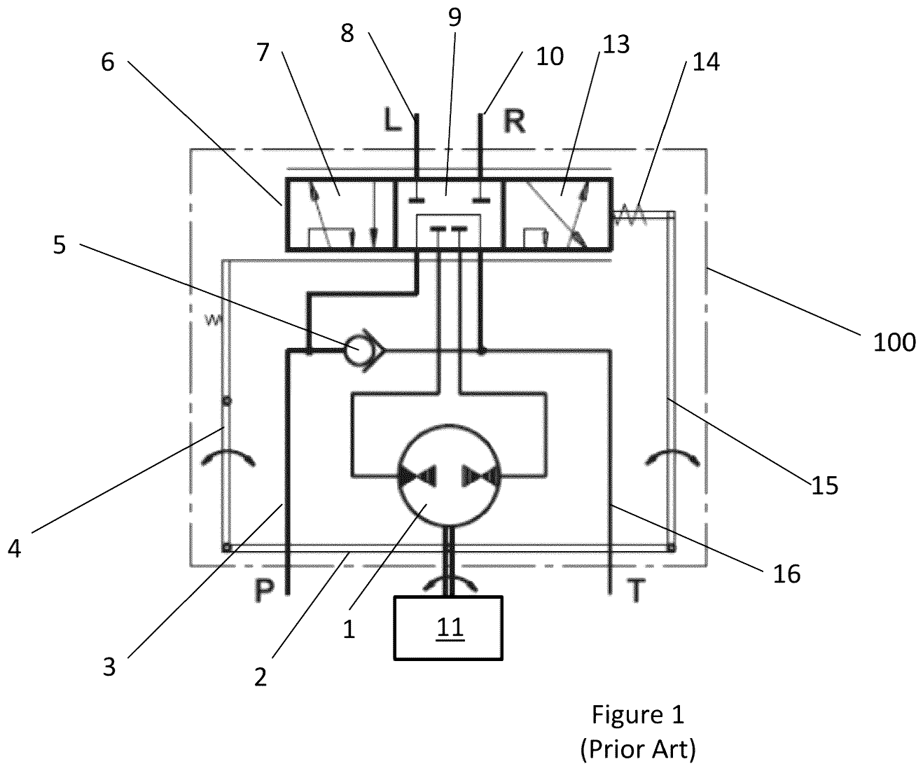

FIG. 2 shows a schematic of an electro-hydraulic metering unit;

FIG. 3 shows a first interface of an intermediate electric positioner interface member;

FIG. 4 shows a second interface of an intermediate electric positioner interface member;

FIG. 5 shows an interface of an electric positioner interface member;

FIG. 6 shows a first interface of an intermediate interface member;

FIG. 7 shows a second interface of an intermediate interface member;

FIG. 8 shows a hand metering unit interface member;

FIG. 9 shows an assembled electro-hydraulic metering unit; and

FIG. 10 shows a block diagram of an electric positioner.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

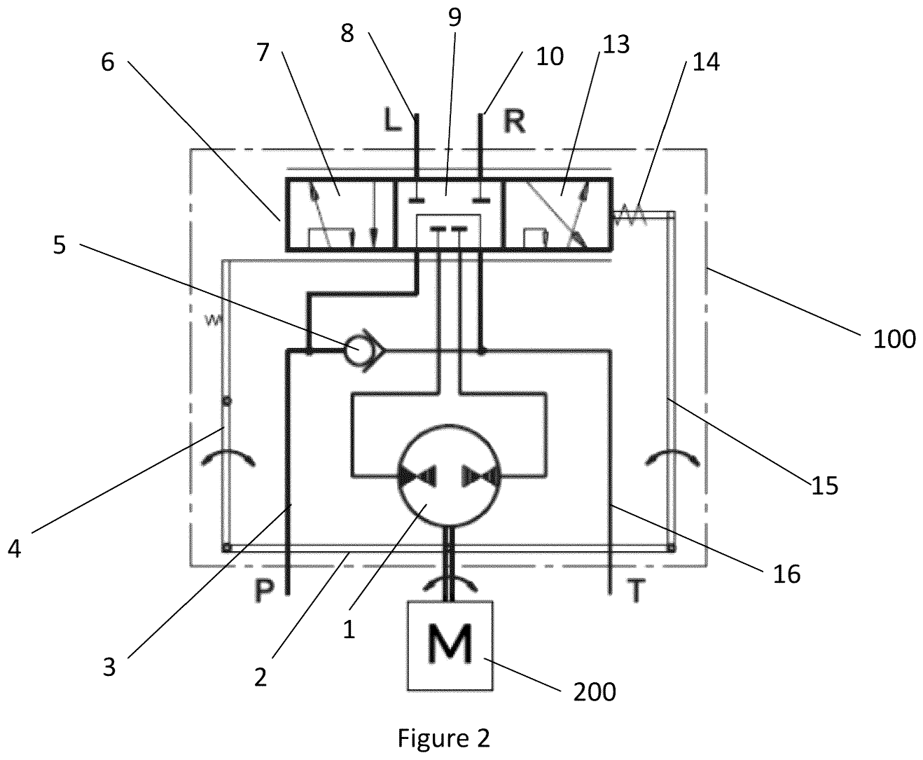

FIG. 2 shows a schematic of an electro-hydraulic metering unit. As illustrated in FIG. 2, a hand metering unit 100 includes a metering element 1, typically a gerotor type positive displacement device, to regulate a fixed volume of oil to be delivered to the hydraulic cylinder/actuator (not shown) per revolution of the steering column/input 11. Drive shafts (2, 4, and 15) connect a directional control servo valve 6 to the metering element 1.

The hand metering unit 100 also includes an inlet fluid port 3 from a pump (not shown). A manual steering check valve 5 allows port T to return oil to port P so that the hand metering unit 100 can act as a hand pump for manual steering when unpowered by hydraulic flow. Port T is the return port that allows oil to return back to a tank (not shown).

When the hand metering unit 100 is powered, high pressure inlet oil at port P closes the manual steering check valve 5 and forces oil towards the directional control servo valve 6 and metering element 1.

With respect to the directional control servo valve 6, block 9 represents a neutral spool position, and blocks (7 and 13) represent flow paths when the valve spool is shifted resulting from steering column input torque.

The hand metering unit 100 includes left turn fluid port 8, outlet to left turn port on hydraulic cylinder or actuator (not shown), and right turn fluid port 10, outlet to right turn port on hydraulic cylinder or actuator (not shown).

As illustrated in FIG. 2, in a neutral spool position, port P is open to port T, left turn fluid port 8 and right turn fluid port 10 are blocked and the metering element 1 is internally blocked/isolated from the directional control servo valve 6. This illustrates one of many “valve center” and “load reaction” variations.

A centering spring 14 maintains neutral state spool position of the directional control servo valve 6 when no load is applied to the steering column/input 11.

An electric positioner 200 is connected to steering column/input 11. The electric positioner 200 provides the input that would normally be supplied from a steering column/wheel.

The electric positioner 200 may be an electric motor and may also include a gearbox to match ideal motor and metering unit rotational speeds. When the electro-hydraulic metering unit is provided with adequate hydraulic oil flow, input torque required to operate the hydraulic portion of the hardware is low; and therefore, a relatively small electric motor can typically be used with minimal electrical power consumption to satisfy heavy duty steering demands.

The hand metering unit 100 does not include any proportional directional valves or servo-proportional valves.

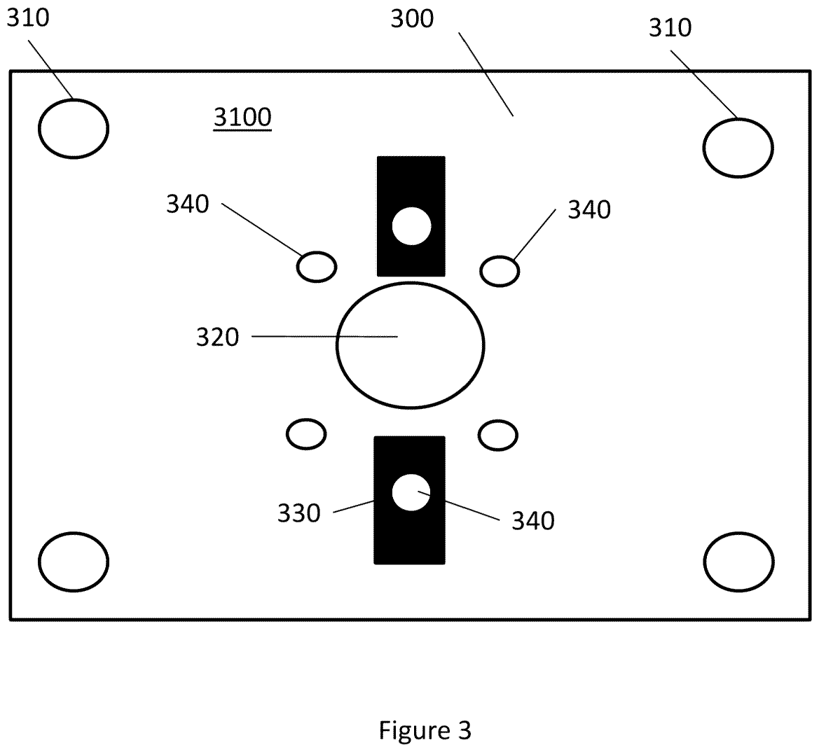

FIG. 3 shows a first interface of an intermediate electric positioner interface member. As illustrated in FIG. 3, an intermediate electric positioner interface member 300 includes a first interface 3100. The first interface 3100 includes through-holes 310 for receiving bolts (not shown), the bolts being used to attach the intermediate electric positioner interface member 300, through an intermediate interface member (not shown), to a hand metering unit interface member (not shown) of a hand metering unit (not shown). The first interface 3100 of the intermediate electric positioner interface member 300 also includes a through-hole 320 for the drive shaft of the electric positioner (not shown) to pass therethrough.

The first interface 3100 of the intermediate electric positioner interface member 300 includes through-holes 340 for receiving bolts (not shown), the bolts being used to attach the electric positioner (not shown), through an electric positioner interface member (not shown) to the intermediate electric positioner interface member 300. Also, the first interface 3100 of the intermediate electric positioner interface member 300 includes topographical interface features (raised plateaus) 330 to correspond to topographical interface features (cavities) (not shown) of an electric positioner interface member (not shown) of the electric positioner (not shown).

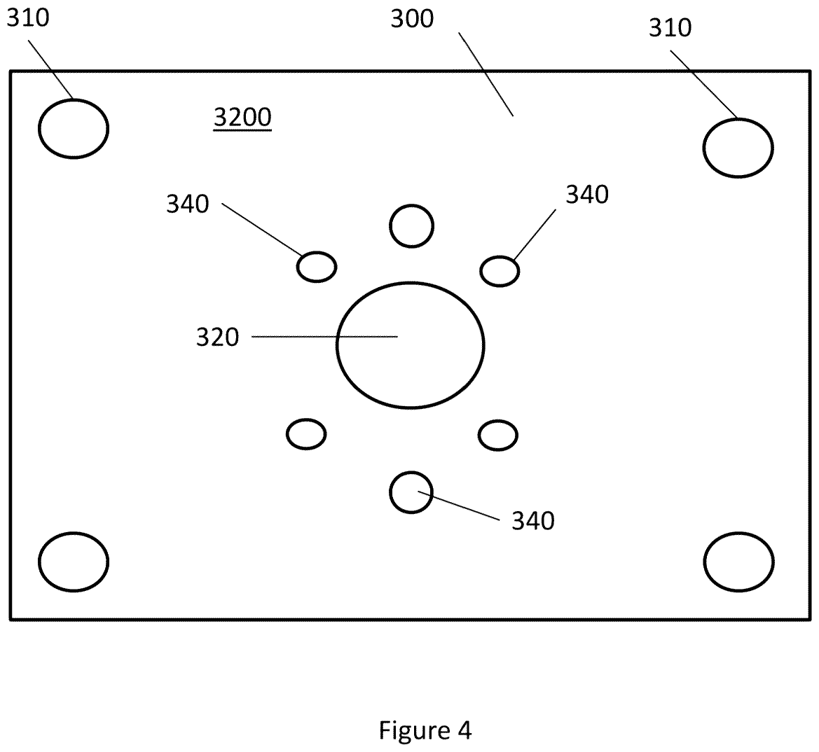

FIG. 4 shows a second first interface of an intermediate electric positioner interface member. As illustrated in FIG. 4, an intermediate electric positioner interface member 300 includes a second interface 3200. The second interface 3200 includes through-holes 310 for receiving bolts (not shown), the bolts being used to attach the intermediate electric positioner interface member 300, through an intermediate interface member (not shown), to a hand metering unit interface member (not shown) of a hand metering unit (not shown). The second interface 3200 of the intermediate electric positioner interface member 300 also includes a through-hole 320 for the drive shaft of the electric positioner (not shown) to pass therethrough.

The second interface 3200 of the intermediate electric positioner interface member 300 includes through-holes 340 for receiving bolts (not shown), the bolts being used to attach the electric positioner (not shown), through an electric positioner interface member (not shown) to the intermediate electric positioner interface member 300.

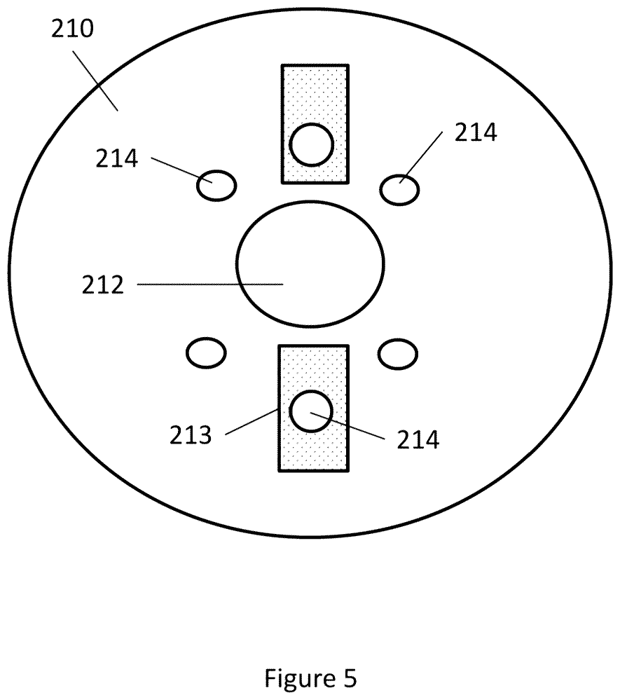

FIG. 5 shows an interface of an electric positioner interface member. As illustrated in FIG. 5, an electric positioner interface member 210 of an electric positioner (not shown) includes topographical interfaces features (cavities) 213, having threaded openings 214 therein for receiving bolts (not shown), and threaded openings 214 for receiving bolts (not shown). The bolts enable the attachment of the electric positioner interface member 210 of the electric positioner (not shown) to the first interface of the intermediate electric positioner interface member of FIG. 3.

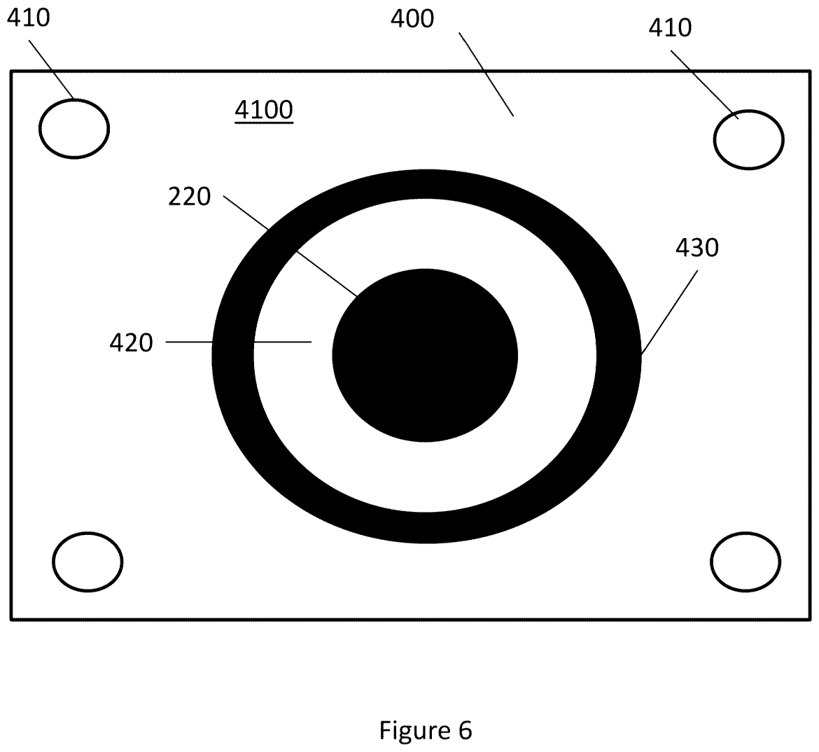

FIG. 6 shows a first interface of an intermediate interface member. As illustrated in FIG. 6, an intermediate interface member 400 includes a first interface 4100. The first interface 4100 includes through-holes 410 for receiving bolts (not shown), the bolts being used to attach the intermediate electric positioner interface member (not shown), through the intermediate interface member 400, to a hand metering unit interface member (not shown) of a hand metering unit (not shown). The first interface 4100 of the intermediate interface member 400 also includes an opening 420 for the drive shaft 220 of the electric positioner (not shown) to pass therethrough.

Additionally, the first interface 4100 of the intermediate interface member 400 includes a topographical interface feature (raised plateau) 430, encompassing the opening 420. The topographical interface feature (raised plateau) 430 corresponds to a topographical interface feature (cavity) (not shown) of a hand metering unit interface member (not shown) of a hand metering unit (not shown).

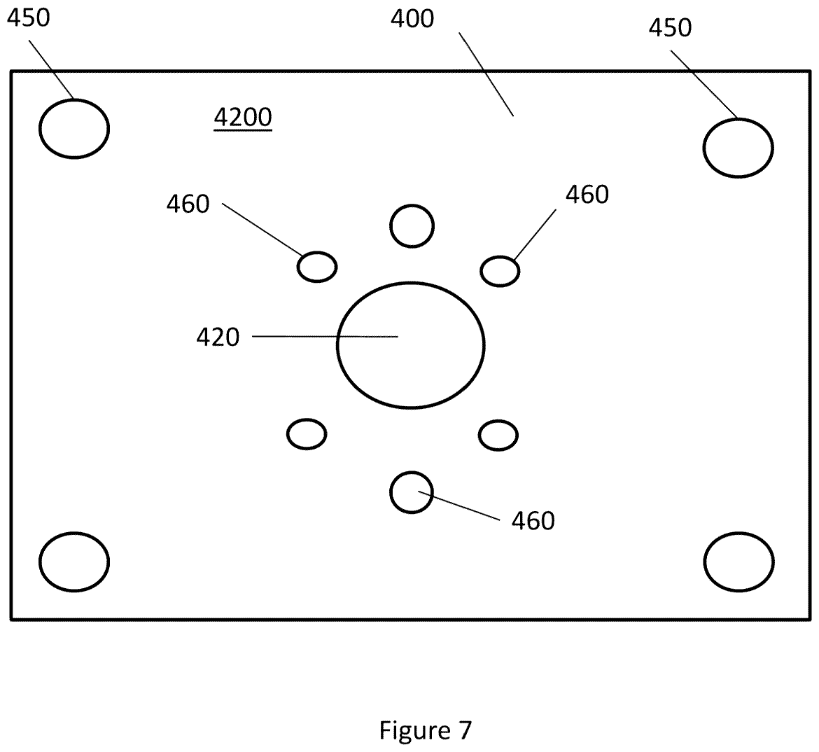

FIG. 7 shows a second interface of an intermediate interface member. As illustrated in FIG. 7, an intermediate interface member 400 includes a second interface 4200. The second interface 4200 includes through-holes 410 for receiving bolts (not shown), the bolts being used to attach the intermediate electric positioner interface member (not shown), through the intermediate interface member 400, to a hand metering unit interface member (not shown) of a hand metering unit (not shown). The second interface 4200 of the intermediate interface member 400 also includes an opening 420 for the drive shaft (not shown) of the electric positioner (not shown) to pass therethrough.

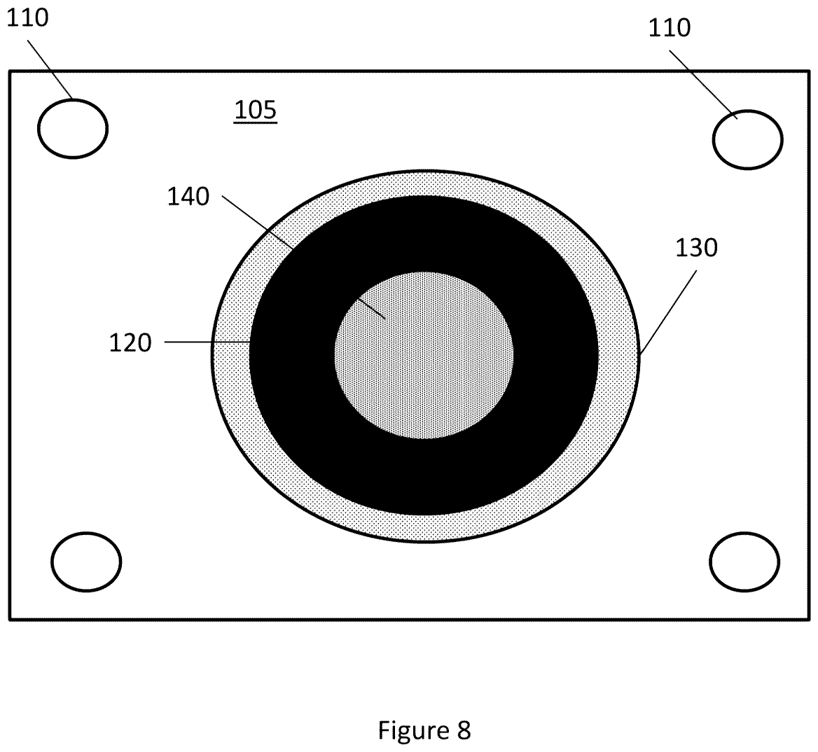

FIG. 8 shows a hand metering unit interface member. As illustrated in FIG. 8, a hand metering unit interface member 105 includes threaded holes 110 for receiving bolts (not shown), the bolts being used to attach the intermediate electric positioner interface member (not shown), through the intermediate interface member (not shown), to a hand metering unit interface member 105 of a hand metering unit (not shown). The hand metering unit interface member 105 also includes an opening 140 for receiving the drive shaft (not shown) of the electric positioner (not shown).

Additionally, the hand metering unit interface member 105 includes a topographical interface feature (raised plateau) 120, encompassing the opening 140. The topographical interface feature (raised plateau) 120 corresponds to the opening of the intermediate interface member. The hand metering unit interface member 105 includes a topographical interface feature (cavity) 130, encompassing the topographical interface feature (raised plateau) 120. The topographical interface feature cavity) 130 corresponds to the topographical interface feature (raised plateau) (not shown) of the intermediate interface member (not shown).

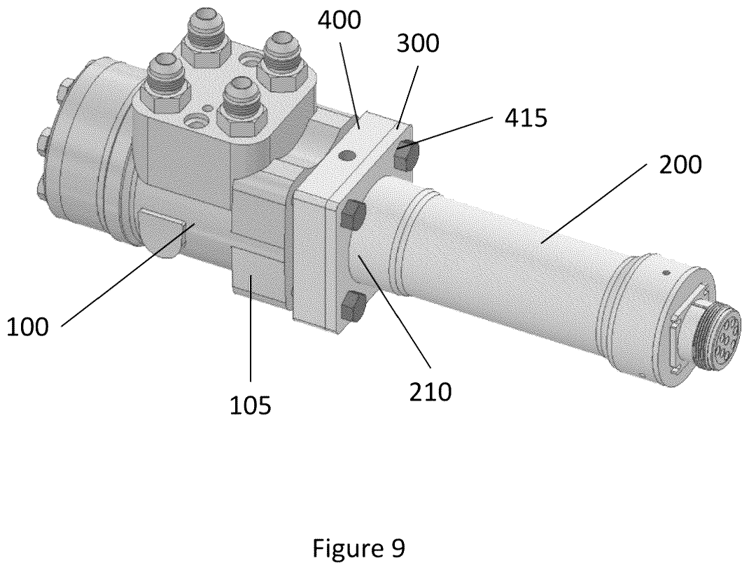

FIG. 9 shows an electric positioner attached to a hand metering unit through an intermediate electric positioner interface member and an intermediate interface member. As illustrated in FIG. 9, an electric positioner 200 includes an electric positioner interface member 210, wherein the electric positioner interface member 210 is attached, via bolts (not shown), to intermediate electric positioner interface member 300. The intermediate electric positioner interface member 300 is attached to intermediate interface member 400, via bolts 415. The intermediate interface member 400 is attached to hand metering unit interface member 105 of a hand metering unit 100, via bolts 415.

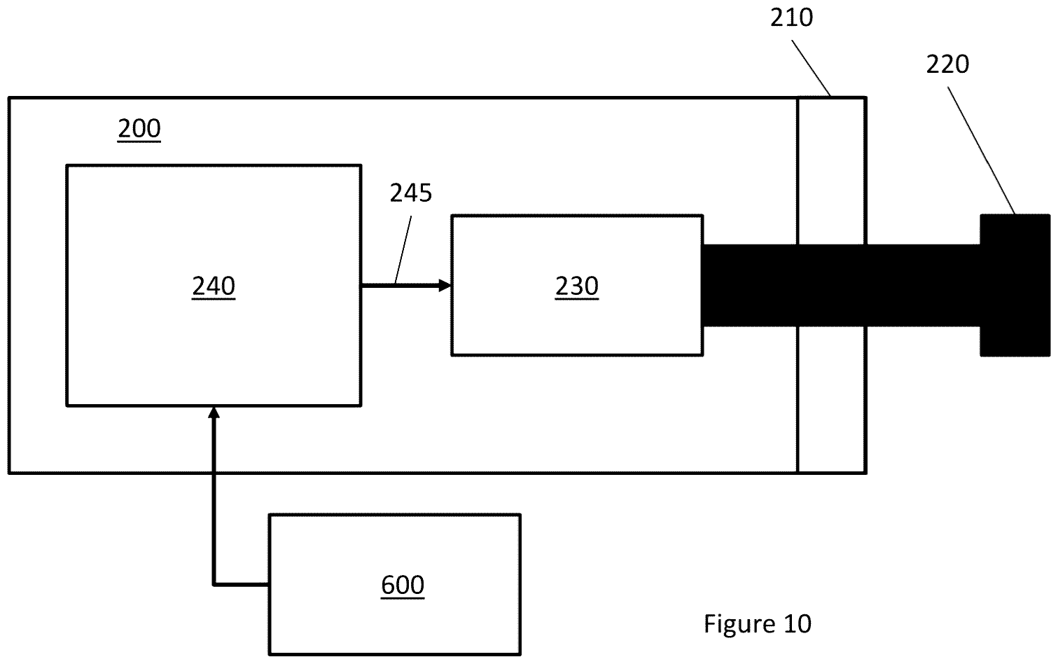

FIG. 10 shows a block diagram of an electric positioner. As illustrated in FIG. 10, an electric positioner 100 includes a motor controller 240 operatively connected to a motor 230. The motor controller 240 processes signals from a control device 600 to determine how to drive the motor 230. The motor controller 240 may be a conventional H-bridge motor controller.

The data from the control device 600 can be used to precisely tune vehicle dynamics and automatically prevent the steering system from trying to steer beyond maximum angle limits, thereby reducing stress on the power steering pump and other components.

The control device 600 may be, for example, a system that includes a controller and vehicle telemetry sensors, which can provide data relating to steering angle and vehicle speed, to the controller 240. The control device 600 may also be an electronic steering wheel/column or a joystick.

The motor 230 is connected to a drive shaft 220. The drive shaft 220 engages, through electric positioner interface member 210, and controls a hand metering unit (not shown).

As described above, rather than using a proportional directional valve or servo-proportional valve, the electro-hydraulic metering unit consists of a hydrostatic steering unit or “hand metering unit” coupled to an electric positioner which provides input that would normally be supplied from the steering column/wheel.

The electric positioner may be an electric motor. The electric positioner may also include a gearbox to match ideal motor and metering unit rotational speeds.

It is noted that the hand metering unit may be a hydrostatic steering unit.

When the electro-hydraulic metering unit is provided with adequate hydraulic oil flow, input torque required to operate the hand metering unit is low; and therefore, a relatively small electric motor can typically be used with minimal electrical power consumption to satisfy heavy duty steering demands.

When compared to a proportional spool or servo-proportional valve, the above-described electro-hydraulic metering unit is easier to accurately control hydraulic actuator rate and position using readily available motor control methods and hardware.

Moreover, the above-described electro-hydraulic metering unit is more tolerant of oil pollution than proportional spool or servo-proportional valves.

Furthermore, the above-described electro-hydraulic metering unit provides an electrohydraulic steering system that has minimal hysteresis.

The above-described electro-hydraulic metering unit provides an electrohydraulic steering system that in the event of electrical power loss, the steering/actuator position will remain fixed in place and the electric positioner can be replaced or supplemented with manual steering input hardware as emergency backup option to adjust steering position.

The above-described electro-hydraulic metering unit provides an electrohydraulic steering system that can easily support open or closed center hydraulic systems without requiring additional or complex valving and controls.

Lastly, the above-described electro-hydraulic metering unit provides an electrohydraulic steering system that enables a steering position to be easily and accurately adjusted by one of several methods including an electronic steering wheel/column, joystick, or automatic controller based on vehicle telemetry feedback.

While the above-described electro-hydraulic metering unit is intended for use, for example, in steer-by-wire and multi-axle steering applications, the nature of the above-described electro-hydraulic metering unit is continuous and infinitely variable, meaning that the above-described electro-hydraulic metering unit can be used for any hydraulic applications requiring precise speed and/or position control of a hydraulic cylinder or hydraulic motor.

The above-described electro-hydraulic metering unit improves the performance, safety, reliability, and cost of proportional electro-hydraulic controls over conventional systems.

An electro-hydraulic metering unit for an electrohydraulic system comprises an electric positioner including a drive shaft; and a hand metering unit operatively connected to the electric positioner; the drive shaft being configured to engage and control the hand metering unit.

The electro-hydraulic metering unit may comprise an intermediate electric positioner interface member operatively connected to the electric positioner.

The electro-hydraulic metering unit may comprise an intermediate interface member operatively connected to the hand metering unit.

The electro-hydraulic metering unit may comprise an intermediate interface member operatively connected to the hand metering unit and the intermediate electric positioner interface member.

The electric positioner may include an electric motor.

An electrohydraulic system comprises an electro-hydraulic metering unit; and a control device; the electro-hydraulic metering unit including an electric positioner operatively connected to the control device, and a hand metering unit operatively connected to the electric positioner; the electric positioner including a drive shaft; the drive shaft being configured to engage and control the hand metering unit.

The electric positioner may include an intermediate electric positioner interface member operatively connected to the electric positioner.

The electric positioner may include an intermediate interface member operatively connected to the hand metering unit.

The electric positioner may include an intermediate interface member operatively connected to the hand metering unit and the intermediate electric positioner interface member.

The electric positioner may include an electric motor.

The control device may be an electronic steering wheel/column.

The control device may be a joystick.

The electrohydraulic system may be an electrohydraulic steering system.

The hand metering unit may be a hydrostatic steering unit.

The control device may be a control system including a controller and vehicle telemetry sensors; the vehicle telemetry sensors being configured to provide data relating to steering angle and vehicle speed to the controller.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

1. An electro-hydraulic metering unit for an electrohydraulic system comprising:
an electric positioner including a drive shaft; and
a hand metering unit operatively connected to said electric positioner;
said drive shaft being configured to engage and control said hand metering unit.

2. The electro-hydraulic metering unit, as claimed in claim 1, further comprising:
an intermediate electric positioner interface member operatively connected to said electric positioner.

3. The electro-hydraulic metering unit, as claimed in claim 1, further comprising:
an intermediate interface member operatively connected to said hand metering unit.

4. The electro-hydraulic metering unit, as claimed in claim 2, further comprising:
an intermediate interface member operatively connected to said hand metering unit and said intermediate electric positioner interface member.

5. The electro-hydraulic metering unit, as claimed in claim 1, wherein said electric positioner includes an electric motor.

6. The electro-hydraulic metering unit, as claimed in claim 1, wherein said hand metering unit is a hydrostatic steering unit.

7. An electrohydraulic system comprising:
an electro-hydraulic metering unit; and
a control device;
said electro-hydraulic metering unit including
an electric positioner operatively connected to said control device, and
a hand metering unit operatively connected to said electric positioner;
said electric positioner including a drive shaft;
said drive shaft being configured to engage and control said hand metering unit.

8. The electrohydraulic system, as claimed in claim 7, wherein said electric positioner includes an intermediate electric positioner interface member operatively connected to said electric positioner.

9. The electrohydraulic system, as claimed in claim 7, wherein said electric positioner includes an intermediate interface member operatively connected to said hand metering unit.

10. The electrohydraulic system, as claimed in claim 8, wherein said electric positioner includes an intermediate interface member operatively connected to said hand metering unit and said intermediate electric positioner interface member.

11. The electrohydraulic system, as claimed in claim 7, wherein said electric positioner includes an electric motor.

12. The electrohydraulic system, as claimed in claim 7, wherein said control device is an electronic steering wheel/column.

13. The electrohydraulic system, as claimed in claim 7, wherein said control device is a joystick.

14. The electrohydraulic system, as claimed in claim 7, wherein the electrohydraulic system is an electrohydraulic steering system.

15. The electrohydraulic system, as claimed in claim 14, wherein said hand metering unit is a hydrostatic steering unit.

16. The electrohydraulic system, as claimed in claim 15, wherein said control device is a control system including a controller and vehicle telemetry sensors;
said vehicle telemetry sensors being configured to provide data relating to steering angle and vehicle speed to said controller.
